(19) United States
(12) Patent Application Publication
(10) Pub. No.: US 2003/0229595 A1
(43) Pub. Date: Dec. 11, 2003

(54) Charging of network access and services

(76) Inventors: Risto Mononen, Espoo (FI); Mia Lahteenmaki, Helsinki (FI); Eero Rasanen, Tampere (FI); Riku Suomela, Tempere (FI)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/161,712

(22) Filed: Jun. 5, 2002

(51) Int. Cl. G06F 17/60

(52) U.S. Cl. 705/63

(57) ABSTRACT

A technique for charging of network access and/or services includes sending a request for least one of network access or services from the user to a network other than the user's home network. A payment request is sent from the network to the user in response to the user's request for the least one of network access and/or services, and a payment information is sent from the user in response to the network's sent payment request. A receipt of a payment is then sent to the user and/or the network in response to the sent user's payment information and a payment confirmation may then be sent from the user to the network in response to the third party wallet's receipt of the payment. The network provides the requested at least one of the network access and/or service to the user upon receiving the payment confirmation of the corresponding at least one of the network access and/or service.

### BACKGROUND OF THE INVENTION

1. Field of the Invention

The present invention relates to charging for wireless network access and services. More particularly, the present invention relates to charging a user for wireless network access and/or services without involving the mobile user's home network operator.

2. Description of the Prior Art

IP (Internet Protocol) technology is presently taking over as a dominant technology in mobile user terminal applications. Furthermore, it is likely that IP will also be the transport technology used to carry traffic in wireless network infrastructure. At the same time, electronic commerce has been increasing and electronic payment methods are being developed to complement and possibly replace current credit card based transactions. Providing a credit card number over the Internet is not secure and subjects the credit card number to theft. Electronic cash (e-cash), on the other hand, solves security issues and enables immediate monetary transactions via the Internet without credit losses, extra costs for invoicing, etc.

Published PCT Application Number WO 00/52921 discloses a technique allowing the user to pay a cellular communications network for service when roaming. The user, when in the user's home network coverage area, communicates with a financial resource over a cellular communications radio link to request an electronic currency credit which is then transferred to the user. When roaming, the user may use the previously transferred electronic currency credit to pay for service to the local network. It is necessary for the user to request and receive the electronic currency credit while in the user's home network coverage area prior to roaming.

Published PCT Application Number WO 00/24160 discloses in detail the interrelationship between a customer terminal and a service provider with regard to the payment for services and the delivery of services. There is no mention of the user paying for services when roaming.

There have been various other publications, which disclose the use of a credit card by the user when the user is roaming in a service area away from the user's home network coverage area. As noted previously, the use of credit cards in this fashion results in security problems.

### SUMMARY OF THE INVENTION

It is therefore an aspect of the present invention provide an electronic charging technique for charging network access and services electronically to an access provider, which may or may not be the home access provider of a user. The electronic charging may occur without involving the user's home operator. Rather, a trusted third party, such as a bank or credit institution, may be used in a transaction between the user and the access provider. The network may be a wireless network and the user may be a mobile user.

Furthermore, it is another aspect of the present invention to provide an electronic charging technique for charging network access and services electronically in which an access provider may provide one or more offers or sets of offers to a user in response to the user's access request. The access network operator offers connection time for the terminal to get a connection to the network operator in order to negotiate or bargain for the service and/or characteristics of a connection to be provided for the mobile terminal. The user of the terminal may then select the most suitable available resource to be used if more than one resource was offered. The access offer forwarded by the access provider may include at least the information that was included in the access request message sent by the user. Typically, such information may include bit rate and service characteristics (that is, properties such as quality of service) and price. For a user, the service characteristics can be presented in terms more suitable for a layman, such as movie quality level, voice quality level, fast Web browsing, slow Web browsing, etc. in order to make the selection of offers easier for the user. In the terminal and network the service characteristics are mapped to the fundamental QoS parameters—bitrate, delay and jitter. The network supports the QoS services with an implementation specific technology. The technique allows a network access provider to dynamically price connection time (that is, to charge more for services that are congested with traffic as compared to services that are lightly loaded) and to dynamically encourage users to select services that are not in full use. The network may be a wireless network and the user may be a mobile user using a mobile terminal.

In the present invention, subscriber authentication and subscriber accounting functions have been separated. This allows for flexibility in the Security Association (that is, the “implicit short term contract”) between the visited access provider and the mobile user's service subscription made with another access operator also known as the home operator. In particular, the home operator does not necessarily participate in accounting for wireless access time. However, the home operator may still set a cost for subscriber and/or equipment authentication if used.

With this new payment arrangement, the user can get service access when roaming. Additionally, the access provider and service provider together can get payment according to the time used and services provided on the basis of the usage of network resources rather than at a flat rate. Additionally, the network can offer the user other possible access channels than those requested, thereby improving the probability that the user will find a suitable satisfactory service. For example, the user may not know what services are available at a particular network. That is, in addition to plain Internet access with different bit rates, the network may offer movies or other radio services. This allows the user to select from several offered options.

Furthermore the access network operator offers connection time for the terminal to get a connection to the network operator in order to negotiate or bargain for the service and/or characteristics of a connection to be provided for the mobile terminal. It may happen that the bargaining does not lead to an agreement meaning that the network operator does not necessary charge the user of the time used for negotiation. On the other hand the network operator may set such a charge to this kind of new payment arrangement and access service, that agreed service offers covers also the connection time spent in non-agreed offers.

Still furthermore, in a WLAN (Wireless Local Area Network) or OWLAN (Operator WLAN), where at present there is no traffic capacity sharing between neighboring cells, the network may implicitly control the channels used in each cell by offering lower cost access rates for less used/camped cells.

Furthermore, it is another aspect of the present invention to provide an electronic charging technique for charging network access and services electronically in which an access provider may provide one or more offers or sets of offers to a user in response to the user's access request. The user may then select the most suitable available resource to be used if more than one resource was offered. The access offer forwarded by the access provider may include at least the information that was included in the access request message sent by the user. Typically, such information may include bit rate and service characteristics (that is, properties such as quality of service) and price. For a user, the service characteristics can be presented in terms more suitable for a layman, such as movie quality level, voice quality level, fast Web browsing, slow Web browsing, etc. in order to make the selection of offers easier for the user.

As used herein, a local network operator is an entity which may be a visited network and is other than the home network of the user of the wireless terminal which contains the user's profile.

The invention has a further embodiment which transmits processed content to at least one terminal. The processed content is produced by at least one processor which receives content from at least one content provider. A profile of the at least one terminal, which may be resident in the at least one processor, controls the processing of the content to provide the processed content provided from the at least one processor to the at least one terminal. The profile may control the processing of the content provided from the at least one content provider so that the processed content has one or more of a maximum and or minimum content price, a maximum image size, a maximum number of bits used to encode a color of image pixels, the processed content is to be only text and the processed content is a further to be compressed beyond compression technique used by the content provider in providing the content to the at least one processor. A wireless service provider may be used to transmit the processed content to the at least one terminal. A billing module may be associated with the at least one processor which generates charges for the transmission of the processed content to the at least one terminal with the charges being a percentage of the cost savings resultant from the transmission of the processed content by the wireless service provider in comparison to the charges the wireless service provider would have charged for transmission of the content received from the at least one service provider without processing thereof.

A method of charging a user for network access and/or services in accordance with the invention comprises the steps of connecting a user of a wireless terminal to a network provided by a local network operator; requesting at least one of a network access or a service by the user of the wireless terminal; and providing from the local network operator a payment request to the user of the wireless terminal, the payment request including a selection of available alternatives for network access and/or services with corresponding charging information, and a selection of available payment methods for the network access and/or services with corresponding payment method information enabling the user of the wireless terminal to effect a payment; sending payment information in response to the user of the wireless terminal making selections based on the payment request, the payment information including at least one selected alternative from the available alternatives for network access and/or services, and personal payment information of the user of the wireless terminal for effecting a payment corresponding to the at least one selected alternative from the available alternatives for network access and/or services; and providing to the user of the wireless terminal in response to a receipt confirming the effected payment the corresponding at least one selected network access and/or service. A receipt confirming the effected payment to the user of the wireless terminal may be sent in response to the effected payment prior to providing to the user of the wireless terminal the at least one selected network access and/or service. The local network operator may provide an additional payment request to the user of the wireless terminal upon the network having completed providing the at least one selected network access and/or service. A selection confirmation message may be sent to the user of the wireless terminal confirming the user made selections for network access and/or service in response to the sent payment information. The selection confirmation message may comprise information relating to the user made selections for payment method. The payment information may be conveyed to a payment service provider. The receipt of confirming the effected payment may be sent from the payment service provider. A receipt may be sent confirming the effected payment to the user of the wireless terminal in response to the effected payment prior to providing to the user of the wireless terminal the at least one selected network access and/or service. The payment service provider may be a third party wallet. The personal payment information may comprise electronic money. The user of the wireless terminal may be provided with information of a selection of available alternatives for network access and/or bargaining for services prior the user sending a communication request for at least one of network access or service. The network may comprise a wireless short range radio network and the wireless terminal of the user may communicate with the short range radio network. The wireless short range radio network may conform to the principles of one of the Bluetooth technology, the IEEE 802.11 Wireless LAN standard and the Hyperlink standard. The requesting for at least one of a network access or a service by the user of the wireless terminal may contain a request for a network connection having at least one specified characteristic. The at least one specified characteristic may comprise one or more of bit rate, quality of service, and time delay. The corresponding charging information of the available alternatives for network access and/or services included in the payment request provided by the local network operator may comprise a cost per unit time information of the available alternatives for network access and/or services. The payment method information included in the payment request provided by the local network operator may comprise an account number of the local network operator. The personal payment information of the user of the wireless terminal included in the sent payment information may comprise an account number of the local network operator, an account number of the user of the wireless terminal, and an amount of money to be transferred from the account number of the user of the wireless terminal to the account number of the local network operator.

A system in accordance with the invention includes a wireless terminal and a network coupled to the wireless terminal by a local network operator; and wherein a user of a wireless terminal is connected to a network provided by a local network operator; at least one of a network access or a service is requested by a user of the wireless terminal; and a payment request is provided from the non-home network operator to the user of the wireless terminal, the payment request including a selection of available alternatives for network access and/or services with corresponding charging information, and a selection of available payment methods for the network access and/or services with corresponding payment method information enabling the user of the wireless terminal to effect a payment; payment information is provided in response to the user of the wireless terminal making selections based on the payment request, the payment information including at least one selected alternative from the available alternatives for network access and/or services, and personal payment information of the user of the wireless terminal for effecting a payment corresponding to the at least one selected alternative from the available alternatives for network access and/or services; and the user of the wireless terminal in response to a receipt confirming the effected payment is provided the corresponding at least one selected network access and/or service. A receipt confirming the effected payment to the user of the wireless terminal may be sent in response to the effected payment prior to providing to the user of the wireless terminal the at least one selected network access and/or service. The local network operator may provide an additional payment request to the user of the wireless terminal upon the network having completed providing the at least one selected network access and/or service. A selection confirmation message may be sent to the user of the wireless terminal confirming the user made selections for network access and/or service in response to the sent payment information. The selection confirmation message may comprise information relating to the user made selections for payment method. The payment information may be conveyed to a payment service provider. The receipt of confirming the effected payment may be sent from the payment service provider. A receipt may be sent confirming the effected payment to the user of the wireless terminal in response to the effected payment prior to providing to the user of the wireless terminal the at least one selected network access and/or service. The payment service provider may be a third party wallet. The personal payment information may comprise electronic money. The user of the wireless terminal may be provided with information of a selection of available alternatives for network access and/or bargaining for services prior the user sending a communication request for at least one of network access or service. The network may comprise a wireless short range radio network and the wireless terminal of the user may communicate with the short range radio network. The wireless short range radio network may conform to the principles of one of the Bluetooth technology, the IEEE 802.11 Wireless LAN standard and the Hyperlink standard. The requesting for at least one of a network access or a service by the user of the wireless terminal may contain a request for a network connection having at least one specified characteristic. The at least one specified characteristic may comprise one or more of bit rate, quality of service, and time delay. The corresponding charging information of the available alternatives for network access and/or services included in the payment request provided by the local network operator may comprise a cost per unit time information of the available alternatives for network access and/or services. The payment method information included in the payment request provided by the local network operator may comprise an account number of the local network operator. The personal payment information of the user of the wireless terminal included in the sent payment information may comprise an account number of the local network operator, an account number of the user of the wireless terminal, and an amount of money to be transferred from the account number of the user of the wireless terminal to the account number of the local network operator.

In a system comprising a wireless terminal and a network coupled to the wireless terminal by a non-home network operation, a method of operation of the wireless terminal in accordance with the invention comprises connecting a user of the wireless terminal to the network; requesting at least one of a network access or a service by the user of the wireless terminal; providing from the local network operator to the user of the wireless terminal a payment request including a selection of available alternatives for network access and/or services with corresponding charging information, and a selection of available payment methods for the network access and/or services with corresponding payment method information enabling the user of the wireless terminal to effect a payment; and wherein the system sends payment information in response to the user of the wireless terminal making selections based on the payment request, the payment information including at least one selected alternative from the available alternatives for network access and/or services, and personal payment information of the user of the wireless terminal for effecting a payment corresponding to the at least one selected alternative from the available alternatives for network access and/or services; and providing to the user of the wireless terminal in response to a receipt confirming the effected payment the corresponding at least one selected network access and/or service. A receipt confirming the effected payment to the user of the wireless terminal may be sent in response to the effected payment prior to providing to the user of the wireless terminal the at least one selected network access and/or service. The local network operator may provide an additional payment request to the user of the wireless terminal upon the network having completed providing the at least one selected network access and/or service. A selection confirmation message may be sent to the user of the wireless terminal confirming the user made selections for network access and/or service in response to the sent payment information. The selection confirmation message may comprise information relating to the user made selections for payment method. The payment information may be conveyed to a payment service provider. The receipt of confirming the effected payment may be sent from the payment service provider. A receipt may be sent confirming the effected payment to the user of the wireless terminal in response to the effected payment prior to providing to the user of the wireless terminal the at least one selected network access and/or service. The payment service provider may be a third party wallet. The personal payment information may comprise electronic money. The user of the wireless terminal may be provided with information of a selection of available alternatives for network access and/or bargaining for services prior the user sending a communication request for at least one of network access or service. The network may comprise a wireless short range radio network and the wireless terminal of the user may communicate with the short range radio network. The wireless short range radio network may conform to the principles of one of the Bluetooth technology, the IEEE 802.11 Wireless LAN standard and the Hyperlink standard. The requesting for at least one of a network access or a service by the user of the wireless terminal may contain a request for a network connection having at least one specified characteristic. The at least one specified characteristic may comprise one or more of bit rate, quality of service, and time delay. The corresponding charging information of the available alternatives for network access and/or services included in the payment request provided by the local network operator may comprise a cost per unit time information of the available alternatives for network access and/or services. The payment method information included in the payment request provided by the local network operator may comprise an account number of the local network operator. The personal payment information of the user of the wireless terminal included in the sent payment information may comprise an account number of the local network operator, an account number of the user of the wireless terminal, and an amount of money to be transferred from the account number of the user of the wireless terminal to the account number of the local network operator.

A system in accordance with the invention includes at least one terminal, each terminal receiving processed content; at least one content provider, each content provider providing content; and at least one processor, each processor, being coupled to the at least one content provider and to the at least one terminal, and processing the content with a profile of the at least one terminal, the profile controlling the processing of the content provided by the at least one content provider to provide the processed content received by the at least one terminal. A wireless service provider may be coupled to the at least one processor and the at least one terminal, which transmits the processed content to the at least one terminal; and wherein the at least one processor, in response to the profile of the at least one terminal, may reduce a quantity of data contained in the content provided from the at least one content provider to provide the processed content received by the at least one terminal from the wireless service provider. The profile may specify a compression level of the processed content provided by the at least one processor, a maximum charge for receiving the processed content by the at least one terminal, a minimum charge for receiving the processed content by the at least one terminal, a maximum size of images in the processed content to be received by the at least one terminal; and the at least one processor processes images within the content received from the at least one content provider to conform images in the content to be within the maximum size of images which may be displayed by a display of the at least one terminal or that the processed content contains only text. A billing module, associated with the at least one processor, may charge for the reception of the processed content by the at least one terminal a fraction of a difference between a charge that the at least one terminal would have been charged by the wireless service provider if the content provided by the at least one content provider was transmitted to the at least one terminal without processing less a charge charged by the wireless service provider for transmitting the processed content to the at least one terminal. The at least one terminal may be a client of the at least one content provider with each content provider comprising a server and the at least one processor being a proxy of the at least one content provider.

A method of providing processed content to at least one terminal in accordance with the invention includes providing at least one content provider which provides processed content; coupling at least one processor to the at least one content provider and to the at least one terminal; and the at least one processor processes the content provided by the at least one content provider to produce the processed content which is received by the at least one terminal in accordance with a profile of the at least one terminal, the profile controlling the processing of the content provided by the at least one content provider to provide the processed content received by the at least one terminal. A wireless service provider may be coupled to the at least one processor and the at least one terminal, which transmits the processed content to the at least one terminal; and wherein the at least one processor, in response to the profile of the at least one terminal, may reduce a quantity of data contained in the content provided from the at least one content provider to provide the processed content received by the at least one terminal from the wireless service provider. The profile may specify a compression level of the processed content provided by the at least one processor, a maximum charge for receiving the processed content by the at least one terminal, a minimum charge for receiving the processed content by the at least one terminal, a maximum size of images in the processed content to be received by the at least one terminal; and the at least one processor processes images within the content received from the at least one content provider to conform images in the content to be within the maximum size of images which may be displayed by a display of the at least one terminal or that the processed content contains only text. A billing module, associated with the at least one processor, may charge for the reception of the processed content by the at least one terminal a fraction of a difference between a charge that the at least one terminal would have been charged by the wireless service provider if the content provided by the at least one content provider was transmitted to the at least one terminal without processing less a charge charged by the wireless service provider for transmitting the processed content to the at least one terminal. The at least one terminal may be a client of the at least one content provider with each content provider comprising a server and the at least one processor being a proxy of the at least one content provider.

In a system including at least one terminal, each terminal receiving processed content and at least one content provider, each content provider providing content, a content proxy in accordance with the invention includes at least one processor, each processor being coupled to the at least one content provider and to the at least one terminal, and processing the content provided by the at least one content provider to produce the processed content which is received by the at least one terminal in accordance with a profile of the at least one terminal, the profile controlling the processing of the content provided by the at least one content provider to provide the processed content received by the at least one terminal. A wireless service provider may be coupled to the at least one processor and the at least one terminal, which transmits the processed content to the at least one terminal; and wherein the at least one processor, in response to the profile of the at least one terminal, may reduce a quantity of data contained in the content provided from the at least one content provider to provide the processed content received by the at least one terminal from the wireless service provider. The profile may specify a compression level of the processed content provided by the at least one processor, a maximum charge for receiving the processed content by the at least one terminal, a minimum charge for receiving the processed content by the at least one terminal, a maximum size of images in the processed content to be received by the at least one terminal; and the at least one processor processes images within the content received from the at least one content provider to conform images in the content to be within the maximum size of images which may be displayed by a display of the at least one terminal or that the processed content contains only text. A billing module, associated with the at least one processor, may charge for the reception of the processed content by the at least one terminal a fraction of a difference between a charge that the at least one terminal would have been charged by the wireless service provider if the content provided by the at least one content provider was transmitted to the at least one terminal without processing less a charge charged by the wireless service provider for transmitting the processed content to the at least one terminal. The at least one terminal may be a client of the at least one content provider with each content provider comprising a server and the at least one processor being a proxy of the at least one content provider.

### BRIEF DESCRIPTION OF THE DRAWINGS

FIG. 1 illustrates an example of the steps of charging of a user for wireless network access and/or services in accordance with an embodiment of the present invention.

FIG. 2 illustrates an example of the steps used for charging of a user for wireless network access and/or services in accordance with another embodiment of the present invention.

FIG. 3 illustrates an example of a server wallet based payment in accordance with another embodiment of the invention.

FIG. 4 illustrates an example of an electronic wallet/cash payment in accordance with another embodiment of the invention.

FIG. 5 is a block diagram illustrating an example of the relationship between the elements of charging of a user for wireless network access and/or services in accordance with another embodiment of the present invention.

FIG. 6 illustrates another embodiment of the invention.

FIG. 7 illustrates a block diagram of the content proxy of the embodiment of the invention illustrated in FIG. 6.

FIG. 8 illustrates a graph of the cost of transmission of content to terminals in accordance with the practice of the invention.

FIG. 9 illustrates a graph of content quality versus compression in accordance with the present invention.

FIG. 10 illustrates a program listing in extensible markup language (XML) for processing images in content from content providers.

FIG. 11 illustrates a group of possible profiles which maybe assigned to the terminals used with the embodiment of FIGS. 6 and 7.

Like parts are identified by like reference numerals throughout the drawings.

### DESCRIPTION OF THE PREFERRED EMBODMIENTS OF THE INVENTION

In the following description of the various embodiments, reference is made to the accompanying drawings which form a part hereof, and in which is shown by way of illustration various embodiments in which the invention may be practiced. It is to be understood that other embodiments may be utilized and structural and functional modifications may be made without departing from the scope of the present invention.

Currently, there must be a roaming contract between a user's home operator and visited operators. In WLAN, OWLAN, and/or Hyper LAN, the terminal user needs to have obtained access rights. The lack of confidence between cellular operators means that both signaling and user traffic always traverse via the home network even though it is not technically necessary. Furthermore, more direct U-plane forwarding is needed to avoid delays when going to Voice over IP networks. As noted previously, there is no traffic capacity sharing between neighboring cells in WLAN networks at present. OWLAN is an operator WLAN having a network in which the access points of the radio connections are connected to a GPRS (General Packet Radio Service) packet data network and in which the mobile terminal in use includes a SIM (Subscriber Identification Module) card. The Wireless LAN Standard is published in three parts as IEEE 802.11-1999; IEEE 802.11a-1999 and IEEE 802.11b-1999, which are available form the IEEE inc. website http://grouper.ieee.org/groups/802/11 which are incorporated herein by reference in their entirety. An overview of the HyperLAN principles and operation is provided in, e.g., publication HyperLAN Type 1 Standard ETSI ETS 300 652, WA2 December, which is incorporated herein by reference in its entirety. In addition to previously mentioned wireless communication techniques, also Bluetooth may be used. Bluetooth is a short range radio technology, originally intended as cable replacement. The Bluetooth Special Interest Group, Specification Of The Bluetooth Systems, Volumes 1 and 2, Core and Profiles: Version 1.1 Feb. 22, 2001 describes the principles of Bluetooth device operation and communication protocols which are incorporated herein by reference in their entirety.

The present invention works with any radio technology, or any type of wireless LAN and other non-licensed technologies and is not limited to current cellular technologies. Setting up a wireless hot spot and charging for access is routine. Selling the access is effected in the same fashion as selling any other services via the network. By separating authentication and the use of a service profile of the home network from the accounting functions dramatically changes the mobile operators business model. A mobile operator no longer has to operate as a credit institution and smaller players may enter the business.

Currently GSM (Global System for Mobile Communications) and SIM combine two unrelated functions, namely, identification and billing. The binding of these two unrelated functions is artificial and benefits only the operators who have large numbers of subscribers visiting other operator networks. There is no reason why a visiting user and the visited network operator need to have the home operator involved to agree on the cost and payment method for radio access.

Direct electronic charging gives the operator a means to direct the mobile user to certain kinds of behavior. That is, current radio resource management has virtually no means to affect mobile oriented cell re-selection although optimal use of resources which require some type of push from the network to the mobile user. For example, RRM (Radio Resource Management) in the access network can use e-charging and access pricing in a way, which actually drives the users to optimal channel selection from the access network point of view.

Furthermore, by paying at the time of ordering the services using an electronic wallet or some other secure payment method, there is no loss to the network operator from unpaid phone bills. Furthermore, there is no danger of the user receiving an unexpectedly high phone bill.

Lastly, in a, e.g., WLAN, the network resource control may attempt to control the cell capacity usage in such a way that by offering low-cost services to a user from a less used cell, the user may be tempted to choose such a cheaper alternative, thereby optimizing the WLAN cell usage for the WLAN operator.

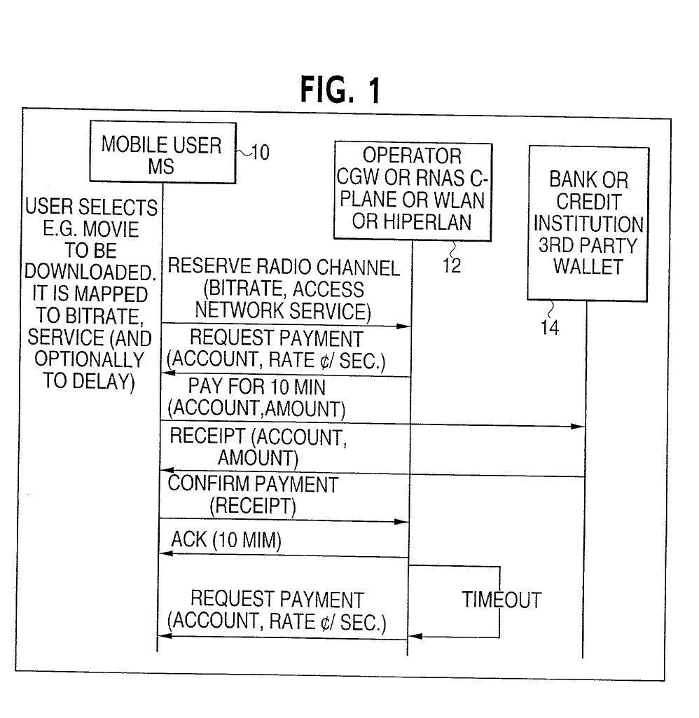

FIG. 1 illustrates an example of the steps of charging of a user for wireless network access and/or services in accordance with an embodiment of the present invention. As shown in FIG. 1, a user, for example, a mobile user MS 10 requests a service from a local network 12. The MS 10 may receive a selection of available alternatives for the service and the MS selects, for example, a movie clip to be downloaded. The selection is then mapped to a bit rate, service, and optionally to an absolute delay (that is, download the movie in 15 minutes, for example) and/or a delay variation (that is, the maximum size of replay buffer that is needed). The information is then sent by the mobile user (shown as Reserve radio channel message in FIG. 1 including bit rate, access network service) to a network operator providing the local network 12.

Prior to that, the wireless terminal of the user has first been switched on and network selection has been started in the terminal. The network broadcasts the network information over a channel to terminal that are listening to the broadcast channel information. It is possible to have additional information included in the broadcasted network information, which indicates that service access can be negotiated without applying the home network roaming agreement concerning the billing of the access service. If the mobile user 10 decides to use a local access network 12 for downloading the movie, a way of paying for the usage of the local access network while using the service is introduced. The user may select a network with which to negotiate. As a result for a user making a network selection via a user interface of the terminal, a request for any or a certain types of connection is sent in a Reserve radio channel message (e.g., in radio network like 2G). If the broadcasted network information does not include information of a negotiation possibility, the network can send the bargaining information in another signaling channel to the terminal.

If any of the previous alternatives do not apply, the user may need to select one network to be used for the service. The user terminal 10 makes a request to the network 12 of the requested service with which the user wants to negotiate.

The network operator 12, shown as the CGW (Cell Gateway) or RANS (RAN Gateway) C-plane payment logic or WLAN or HyperLAN in FIG. 1, upon receiving the information from the user, forwards a payment request to the user indicating a selection of available alternatives for network access and/or services with corresponding charging information and a selection of available payment methods for the network access and/or services with corresponding payment method information enabling the user of the wireless terminal to effect a payment. The payment request may include the account number of the operator, reference number, and the payment rate for services, e.g., 0.01 cents/second. Any available wireless technique for accessing the network can be used, such as, e.g., GSM, GPRS, DECT or UMTS or. A connection according to the IEEE 802.11 WLAN or a Bluetooth connection can used, but also an infrared-based connection is possible.

Upon receiving this information from the operator 12, the user may select the preferred service and either an amount to be paid or selects a period of time, which, upon multiplication by the rate for services, results in an amount to be paid. This amount, together with the account number of the operator and user information, such as the user's account number, may be forwarded as a Pay request or payment information upon user selections. The payment information sent by the wireless terminal of the user is sent directly to payment service provider 14. This can be a bank or credit institution or the operator itself acting as a payment provider.

With this method, it is not necessary for either the user or the operator to contact the user's home operator in order to complete the transaction.

The payment service provider 14, upon receiving the Pay request from the user, debits the user's account the requested amount and credits the requested amount to the operator's account and then forwards a Receipt message indicating the amount and the account number to which the amount was credited. The receipt message may be sent to both the local network operator and the user. The details of this will be discussed in detail below.

Upon receiving the Receipt message, the user may then forward a confirmation of payment to the local network operator 12 as a Confirm payment message and upon receiving Confirm payment message from the user the operator may send an Acknowledgement message to the user. Then the requested and paid service is performed, which in this case was the downloading of 10 minutes of a selected movie. The Acknowledgement message is optional and the user may use the access network or services without receiving the Acknowledgement message.

Once the service that the mobile user 10 has requested and paid for is performed, the operator may then send a new payment request to the user, thereby allowing the user to either request and pay for additional services provided by the operator or to disconnect if no additional service is needed.

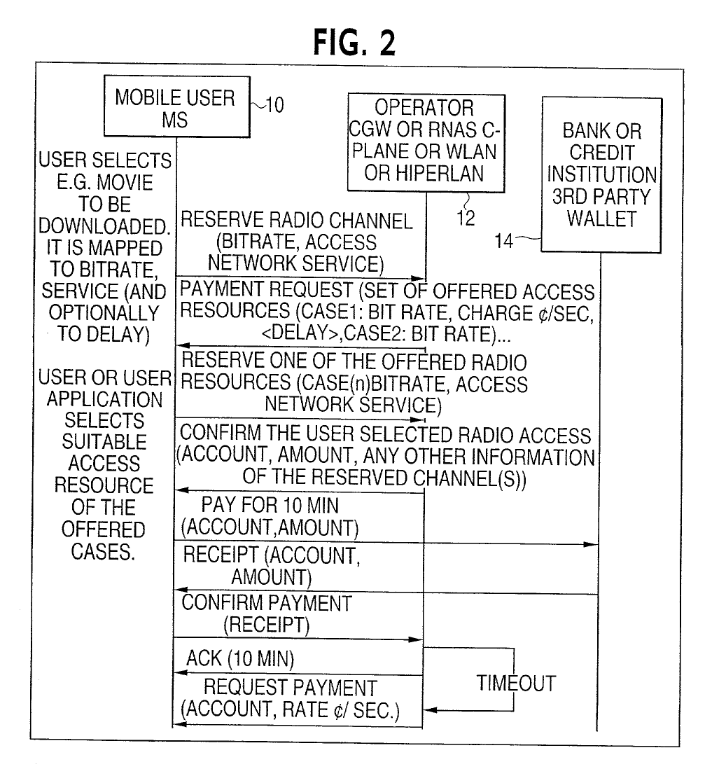

FIG. 2 illustrates an example of the steps of charging of a user for wireless network access and/or services in accordance with another embodiment of the present invention. FIG. 2 differs from FIG. 1 in that in the technique of FIG. 2, in response to the Reserve radio channel message from the user 10 to the network operator 12, the network operator forwards a Payment request message containing choices of offered access resources to the user. That is, the network operator 12 may offer a CASE1 option of a first bit rate at a first payment rate for services and then may offer a CASE2 option of a second bit rate at a second payment rate for services, etc.

Prior to the above sequence, the terminal has been switched on and network selection is started in the terminal 10 as described in FIG. 1.

In response to the Payment request options forwarded by the network operator 12 to the user 10, the user forwards a Reserve radio resources message indicating to the network operator which option, e.g., CASE1 or CASE2, etc.

In response to the Reserve radio resource message from the user, the network operator may forward a Confirmation of selected radio access message to the user, which may include the network operator account number and payment rate and may also include further information regarding the selected option.

The remaining steps illustrated in FIG. 2 are identical to those of FIG. 1. In the steps illustrated in both FIG. 1 and FIG. 2, the payment receipt in response to an effected payment by the user 10 may be sent directly to the operator 12 rather then being sent to the user and then forwarded to the operator.

In this fashion, the user 10 is given options with regard to the characteristics of the radio resource and its payment rate. Furthermore, by allowing the network operator 12 to offer options to the user, the network operator can better utilize the available radio resources by pricing under utilized resources at a lower cost as compared with highly utilized resources, thereby making the under utilized resources more desirable to the user.

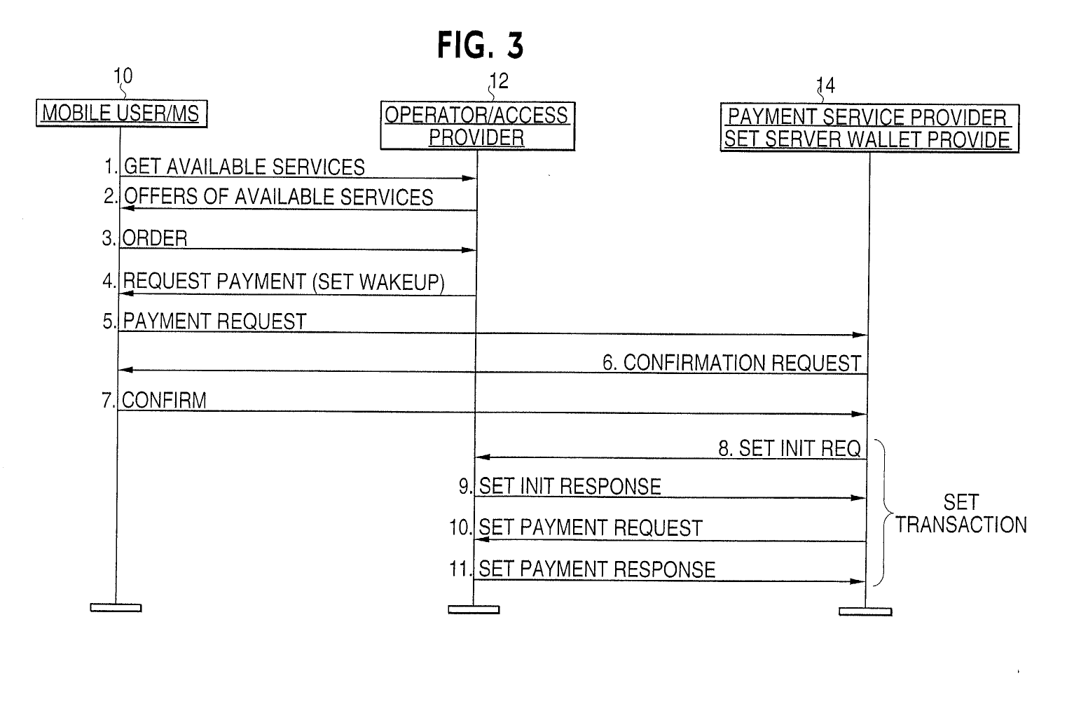

FIG. 3 illustrates an example of a payment using a server wallet based payment method. The server wallet, which is a payment service provider, supports SET (Secured Electronic Transaction) protocol, but other payment protocols may also be used. The SET specification is an open technical standard for the commerce industry developed by Visa and MasterCard as a way to facilitate secure payment card transactions over the Internet. Digital Certificates create a trust chain throughout the transaction, verifying cardholder and merchant validity.

First it is assumed that the terminal is switched on, and network selection is started in the terminal as described in relation to FIG. 1.

As illustrated in FIG. 3, in step 1, the user 10 forwards a request to the operator 12 asking for the available services after user has made a decision of the access network to be used as in FIG. 1. In response to that, in step 2, the operator 12 forwards offers of available services to the user 10. The user 10 then selects the desired service from the available services and forwards an order to the operator 12 in step 3. In response thereto at step 4, the operator 12 forwards a selection of available payment methods for the ordered service with corresponding payment method information enabling the user of the wireless terminal to effect a payment in step 4. In step 5, the user 10 forwards a personal payment for effecting the payment corresponding to the ordered service to the payment service provider 14 or SET server wallet provider. In step 6, the payment service provider 14 forwards a confirmation request to the user who in turn, in step 7, may forward a confirmation to the payment service provider 14. This confirmation may be in a form of a digital signature if the terminal 10 or secure module in the terminal supports the digital signaling. In step 8, the payment service provider 14 forwards a SET initiation request to the operator who, in step 9, answers with a SET initiation response. In step 10, the payment service provider 14 forwards a SET payment request to the operator 12 who, in step 11, forwards a SET payment response.

It should be understood that one or more steps can be combined, for example steps 2 and 4 can be combined, in which case also steps 3 and 5 can be performed in one step. That is the network operator 12 forwards offers of available services with payment method information to the user 10 and the user responds that by selecting the preferred service and incorporates personal payment information to that message. It should also be noted that payment service provider 14 may be under control of the network operator 12.

An example of a server wallet based system is a SET payment over WAP. This can benefit from the WIM (WAP identity module) on the mobile terminal 10 by using, e.g., digital signatures for user authentication and getting the confirmation for the payment from the user if WAP security layer client authentication is not available. The user can be authenticated and the payment confirmation received by the user signing the confirmation text. This requires WAP WIM functionality on the mobile terminal 10. If WIM is not available, the server wallet can authenticate a user via password as presently occurring in the PC/Web situation, or by other means generally used for authentication.

Note that for the purpose of brevity, the specific details of the WAP, SET, and WTLS protocols have been omitted. However such details are easily available publicly from the various organizations promulgating these protocols and accordingly, the details of such protocols are incorporated by reference herein in their entirety. For example, WAP specifications are available on the Internet at http://www.wapforum.org. The WTLS (Wireless Transport Layer Security) specification is included in WAP specification and can be found on the Internet at the same address.

Furthermore, while the example embodiments in accordance with a present invention have been described with reference to specific networks and interface protocols, it is of course understood that the present invention is not limited thereto.

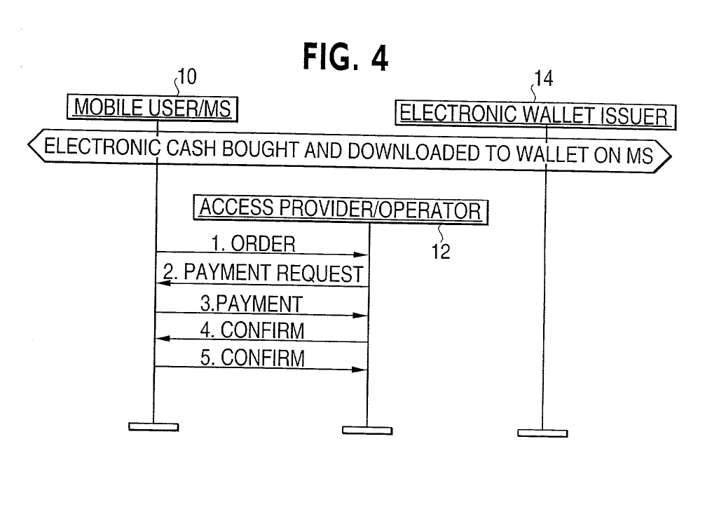

FIG. 4 illustrates an example of the use of an electronic wallet/cash payment. In such an arrangement, the operator/access provider 12 has servers that support the application and can be used to upload cash to the electronic wallet issuer 14 and change it into money when needed. Electronic cash applications without smart card based wallets could also be used in the same fashion. As illustrated in FIG. 4, subsequent to the electronic cash being bought and downloaded to the wallet of the user, in step 1, an order is forwarded from the user to the operator who in turn forwards a payment request to the user in step 2. In step 3, the user 10 forwards payment to the operator 12 who in turn forwards a confirmation to the user in step 4 who in turn forwards a confirmation back to the operator in step 5.

The payment transaction protocol supported by the electronic wallet or cash application may require different communications between the user/mobile terminal 10 and the access provider/operator 12, but the operation is the same. FIG. 4 shows just one example embodiment of the use of an electronic wallet/cash payment according to the present invention.

In the payment arrangements of FIGS. 3 and 4, it was not necessary for the user or operator to contact the user's home network operator to conduct a transaction.

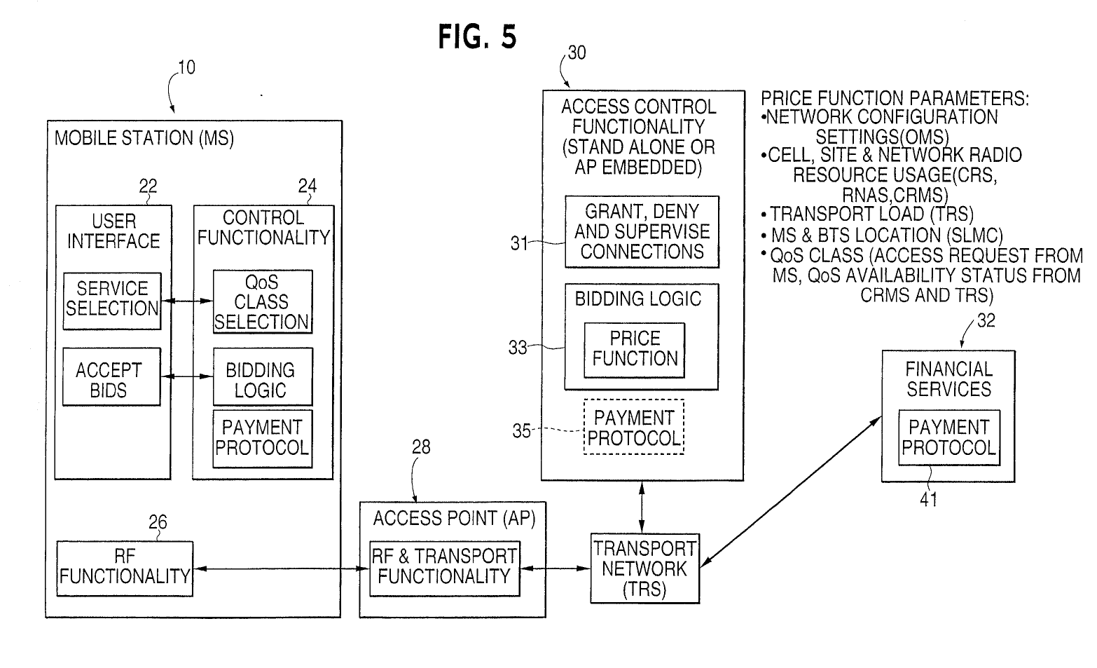

FIG. 5 is a block diagram illustrating an example of the relationship of the elements used for charging of a user for wireless network access and/or services in accordance with an embodiment of the present invention. As shown in FIG. 5, the MS 10 of the user includes a user interface 22 allowing the user to select services and except bids by the network and Control functionality 24, which includes QoS (Quality of Service) selection and Bidding logic and Payment protocol. The MS further includes RF functionality 26 allowing communication with an AP (Access Point) 28, which includes both RF, the radio access network and transport functionality, a gateway such as a WAP gateway or a core network switch and a gateway to external networks. The AP connects to a TRS (Transport Network) which in turn connects to Access control functionality 30, either stand-alone or AP embedded, and to Financial services 32. Financial services 32 include a Payment protocol 41 whereas the Access control functionality includes Grant, deny, and supervise connections, Bidding logic 33 including Price function and Payment protocol 35. The Price function parameters may include but are not limited to: Network configuration settings, Cell, site, and network radio resource usage (CRS, RNAS, CRMS), Transport load (TRS), MS & BTS Location (SLMC), and QoS class (access request from MS, QoS availability status from CRMS and TRS).

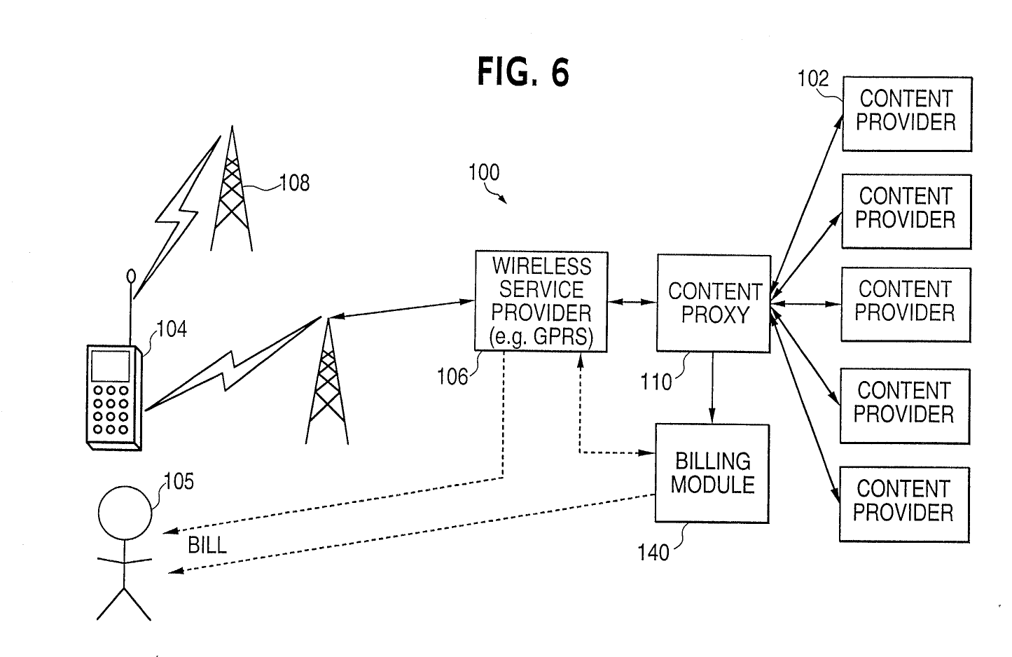

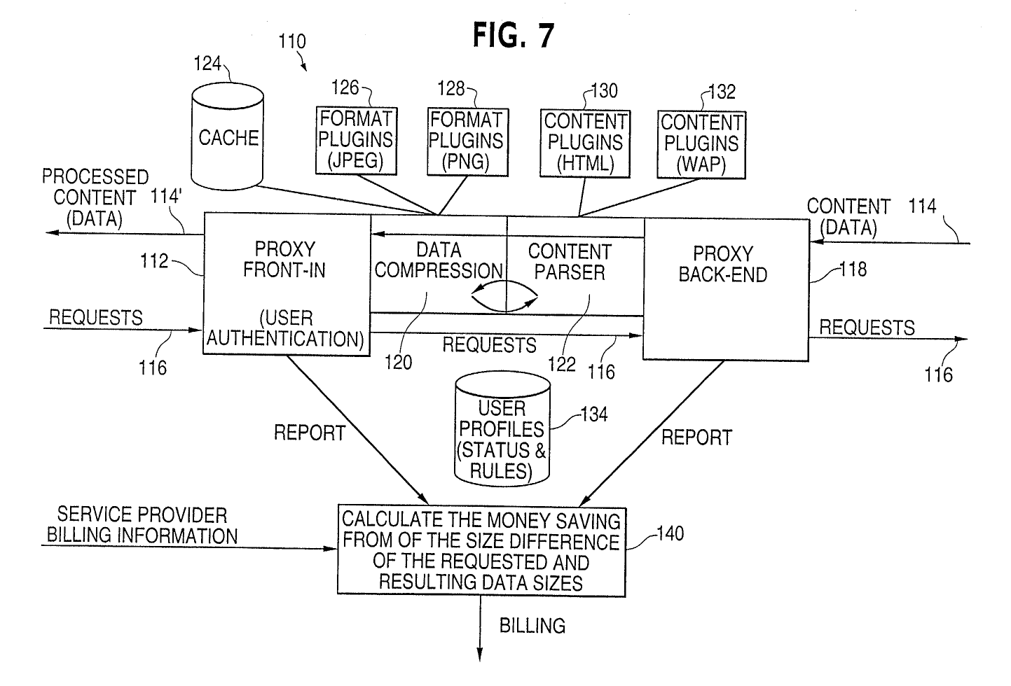

FIGS. 6 and 7 illustrate an embodiment 100 of the present invention which provides content from a plurality of content providers 102 to a plurality of mobile terminals (only one is illustrated) 104 via wireless transmission from a local wireless service provider 106 having a plurality of base stations 108. The base stations 108 transmit content (illustrated as PROCESSED CONTENT 114′ in FIG. 7) to the plurality of mobile terminals 104 and receive requests from the mobile terminals 104 that content reception from at least one content provider 102 is desired (illustrated as REQUESTS 116 in FIG. 7). The content providers 102 comprise servers which provide content, including typically text and images, upon requests from requestors including the users 105 of the terminals 104. A content proxy 110, comprising at least one processor, is coupled between the plurality of content providers 108 and the local wireless service provider 106. The content proxy processes the content received from the content providers 102 to produce processed content 114′ for transmission to at least one mobile terminal 104. The processing is controlled by profiles of the terminals 104 stored in storage 134. However, it should be understood that the invention is not limited to storage of the profiles in the content proxy 110. Such alternative storage may be within the wireless service provider 106 in a register storing user information of the terminals 104, such as a home location register or within another service providers home location register accessible by the local wireless service provider 106. In a wireless network, the home location register typically contains the user profiles of the users of the mobile terminals of the wireless service provider.

The processing performed by the at least one processor of the content proxy 110 reduces the quantity of data transmitted to the plurality of mobile terminals 104 into processed content 114′ which contains less data than the content 114 received from the at least one content provider 102. The content proxy 110 processes the content 114 provided by at least one of the content providers 102 in response to a request 116 for content from at least one of the plurality of mobile terminals 104 in accordance with a profile, preferably stored in the storage 134 of FIG. 7 at the content proxy, of at least one terminal. The profiles control providing of the processed content 114′ which is transmitted to the at least one terminal 104. As a result of the at least one processor of the content provider 110 processing content 114 from the at least one content provider 102 which is requested with a request 116 from at least one of the mobile terminals 104 in dependence upon the profiles, the conditions of data transmission are readily controlled, including the cost of transmission, the bandwidth consumed during the transmission and the form of the data, such as controlling of the display (not illustrated) used by each of the plurality of the mobile terminals 104. The providing of the charge for the processed content 114′ from the billing module 140 may be directly to the user 105 or to the local wireless service provider 106 which provides the user with the charge for the processing by the content proxy 110 in preparing the processed content 114′, such as with a monthly statement.

Effectively, the profiles of the plurality of mobile terminals 104 utilized by the content proxy 110 provide a control mechanism for data transfer of the content 114 by the content providers 102 as processed content 114′ to the mobile terminals. The processed content 114′ is controlled in accordance with conditions expressed in the profiles and specified by the users 105 of the plurality of mobile terminals 104 to control the charge for the transmissions of the processed content to the users.

Current business models of general packet radio service (GPRS) providers suggest that a price is to be charged to a user of a mobile terminal 104 dependent upon the bandwidth required to transmit the content. However, most users 105 of mobile terminals 104 wish to control the overall cost of obtaining content from the content providers 102 via the local wireless service provider 106. As a result, with the invention, the users 105 of the plurality of mobile terminals 104 create a personal profile 134 utilized by the content proxy 110 to control the quantity of data transmitted and the conditions of transmission which the users are willing to accept. This control typically lowers the cost to the users of receiving the compressed content 114′.

The billing module 140, which may be external to the content proxy, as illustrated in FIG. 6, or internal thereto, as illustrated in FIG. 7, charges the users 105 of the plurality of mobile terminals 104 a percentage of the savings in the transmission charges of the local wireless service provider 106 resultant from the transmission of the processed content 114′. The savings result from restricting the quality and/or quantity of the processed content 114′ or otherwise controlling the transmission of content from the content providers 102 to the mobile terminals 104 by the generation of the processed content. The billing module 140 provides a statement for the user 105 of the at least one terminal 104 charging the user a fraction of a difference between a charge that the at least one terminal 104 would have been charged by the local wireless service provider 106 if the content from the at least one content provider 102 was provided to the at least one terminal without processing performed by the content proxy 110 less an actual charge charged by the wireless service provider for providing the processed content 114′ from the at least one processor to the at least one terminal 104.

For example, a reduction in the amount of data in the content 114 by a factor of ten to produce the processed content 114′ provides an overall cost savings of 90% of transmission under normal charges of the wireless service provider which are proportional to the quantity of data which is transmitted. This savings is substantially passed on to the users 105 of the at least one terminal 104. This savings provides a margin sufficient to charge the users 105 for the service of the billing module 140 associated with the content proxy 110. An overall savings is given to the users 105 of the mobile terminals 104 providing a revenue stream to the operator of the content proxy 110 to pay for processing the content 114 to generate the processed content 114′. While the overall quality of the processed content 114′ provided to the users 105 of the plurality of mobile terminals 104 is less, as long as the overall quality is acceptable to the users, substantial savings result which provide a basis for commercially operating the content proxy 110 to the benefit of the users and the operator of the content proxy 110. The data size of the processed content 114′ delivered to the users 105 of the mobile terminals 104 is reduced according to the users profile 134 in the content proxy 110 so that less cost is incurred with the reception of the data contained in the processed content resultant from the control exercised by the profiles of the content proxy 110 located between the content providers 102 and the mobile terminals 104.

In the system illustrated in FIGS. 6 and 7, the mobile terminals 104 function as a client, the content providers 102 are servers and the content proxy 110 functions as a proxy for the content providers 102.

The embodiment 100 permits the users 105 of the mobile terminals 104 to minimize bandwidth required for browsing content from the content providers 102 on packet data networks such as the internet. Furthermore, the content proxy 110, in addition to discarding data in the content 114 provided thereto by the content providers 102, also can compress the content 114 to be transmitted to the users as processed content 114′ to save the overall bandwidth of the wireless connection.

The present invention overcomes a number of problems associated with mobile terminals 104 of different designs. A problem which most users 105 of mobile terminals 104 experience is that the cost of using a local wireless service provider 106 or any corresponding service provider is directly proportional to the size of the content transmitted to the user. This provides the wireless service provider the maximum benefit but results in substantial charges to the users. Furthermore, mobile terminals 104 with different capabilities exist which necessitates that the content 114′ provided by for example the local wireless service provider 106 to different types of mobile terminals must be varied in order to effectively and efficiently provide content to the users 105. For example, a mobile terminal 104 with a black and white display could receive a full 24-bit color image from a content provider 102 while the mobile terminal only requires one bit per pixel to drive a black and white display thereof. In this circumstance, without reduction in the size of the processed content 114′ transmitted by the local wireless service provider 106 by the content proxy 110, a significant charge to the user 104 of the mobile terminal 104 would be incurred. This charge would be totally unfair since the user 105 would not obtain any benefit from the color information given the black and white display capability of the user's terminal 104.

An example of processing of an image to lessen quality is the processing of a JPEG compressed image of a size of 640×480 pixels with 95% quality. In this example, the mobile terminal 104 is only capable of viewing an image of 95×86 pixels. The size of the original image is 100 kilobytes. The profile of the mobile terminal(s) 104 to receive JPEG images is specified in the user profile 134 of the content proxy 110 as permitting a maximum quality of 50% and a maximum size of 95×86 pixels. When the image 114 is received from the content provider 102 by the content proxy 110, the content proxy decodes the image to an uncompressed format, resizes the image to fit the 95×86 pixel dimension display format and compresses the image again with a 50% quality. Thereafter, the image size of about 10 kilobytes as processed content 114′ is transmitted to the mobile terminal 104.

Furthermore, the present invention provides additional revenue possibilities for the content providers 102. If the overall bandwidth which the mobile terminals 104 can receive becomes substantially utilized, the content providers 102 may gain additional revenues beyond providing the original content 114 by reducing the content provided to the content provider 110 to generate a charge provided to the users 105 directly or via the wireless service provider 106. This permits additional mobile terminals 104 to be serviced by the local wireless service provider 106 while generating additional revenue for the benefit of the content providers 102. In other words, the content providers 102 can offer content services to more clients without the risk of a congested network local wireless service provider 106, so the resulting profit may be enhanced if the content providers can provide a selection of services to a greater number of users 105.

One possible architecture of the content proxy 110 which may be used with the practice of the present invention is explained with reference to FIG. 7. The content provider 110, as stated above, contains at least one processor which performs the functions of being a proxy front end 112 including user authentication and transmitting processed content 114′ of reduced quality to the mobile terminals 104 and receives requests 116 from the content providers 102 for obtaining content functions as a proxy back end 118, which receives the content transmissions 114 from the content providers 102 and transmits the requests 116 thereto. Additionally, the at least one processor performs data compression routines 120 and content parsing 122 which are well known. The data compression and content parser functions have access to cache memory 124, format plug-ins 126 and 128 for JPEG and PNG image processing and content plug-ins 130 and 132 for hypertext mark up language (HTML) and wireless application protocol (WAP) protocol transmissions during processing. Memory storage 134 stores the user profiles which include the status of the mobile terminals 104 and rules for providing content, such as, but not limited to the rules described above and below in conjunction with FIG. 11. Billing module 140 calculates a money savings from a size difference between an amount of data contained in the content 114 from the content providers 102 provided to the content proxy 110 and an amount of data which the mobile terminals 104 have specified as being acceptably received in accordance with the user profiles stored in the memory 134 which is transmitted as the processed content 114′ by the wireless service provider 106 or the like. The billing module 140 is responsive to reports from the front end proxy 112 and the back end proxy 118 which provide a basis for calculating the savings that can be used for billing. The size of the content 114 that is received from the content providers 102 is reported by the proxy back-end 118 and is compared with the processed content 114′ after compression etc. that is reported by the proxy front-end 112 to permit a calculation of the savings. The benefit to the users 105 can be calculated and the content proxy 110 or operator thereof can claim or charge the users an additional fee that is based on the cost savings resulting from the compression, etc. The billing module 140 also receives service provider billing information from the local wireless service provider 106 from which the mobile terminal 104 receives wireless service. The billing module 140 provides billing outputs.

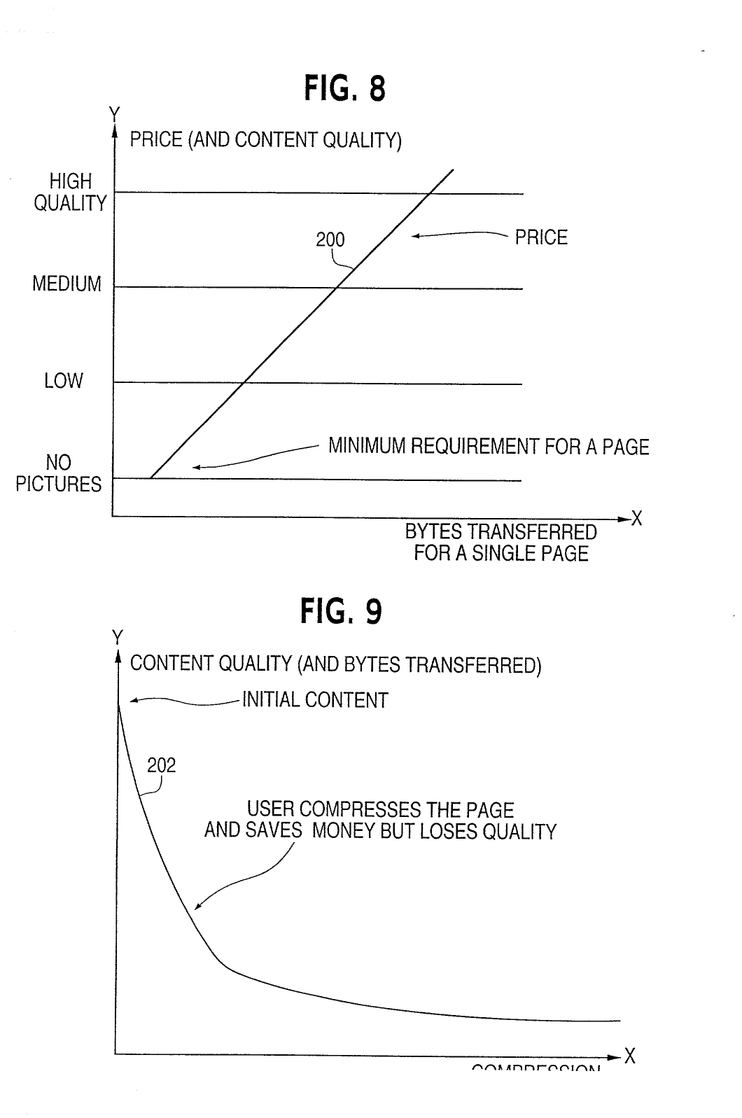

FIG. 8 illustrates the price charged by the local wireless service provider 106 or for the transmission of content provided by the content providers 102 as a function of bytes of data transferred. As can be seen, the price charged by the local wireless service provider 106 is a linear function 200 of the number of bytes on the X axis transferred over the wireless link from the base station 108 to the mobile terminals 104. The minimum amount of transmitted data on the Y axis occurs when there is an absence of pictures. The price of the data transmission is also proportion to the quality of data with low, medium and high quality data being successively more expensive in accordance with the linear function 200.

FIG. 9 illustrates a graph of content quality vs. compression. As may be seen, the curve 202 representing the quality of the content falls significantly from the initial highest quality content at the intersection with the Y axis to a lesser quality which asymptotically approaches a minimum quality as compression increases along the X axis.

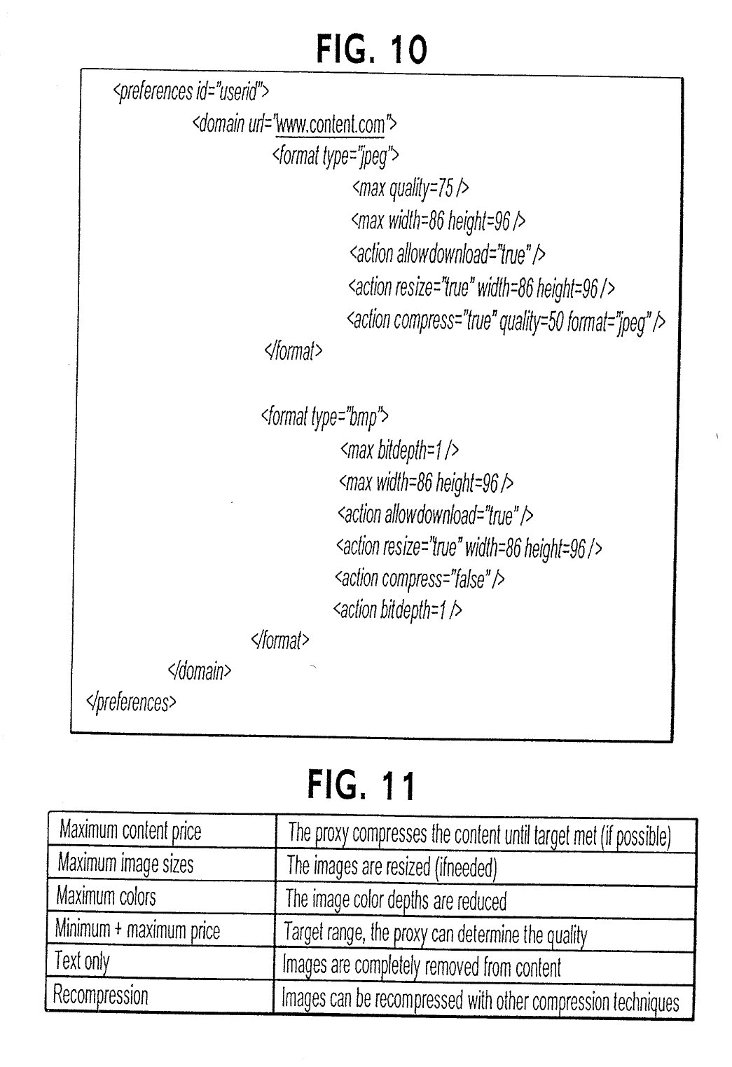

FIG. 10 illustrates an extensible mark-up language (XTML) routine which is exemplary of how reformatting of raw image data from the content providers 102 may be reconfigured to a set pixel size and image quality. It should be understood that a user can change a previous setting in accordance with the routine of FIG. 10 through a HTML interface (or any other interface supported by the content proxy 110). The user is given a set of choices for each file format according to capabilities of the file format and the mobile terminals 104. The user can change values of the settings between the minimum and maximum values evaluated from the capability information. It is possible to have a different profile for each of the content providers 102 and the user 105 may specify one profile for all of the content providers.

The profile 134 of the plurality of mobile terminals 104 may use diverse criteria for controlling the delivery of the content as illustrated in FIG. 1: the content proxy 110 compresses the content 114 until a maximum target price is met; images in the content 114 provided by the content providers 102 are resized and typically reduced in pixel content to conform to a maximum size; a color depth used for encoding pixels in images contained in the content 114 provided by the content providers 102 is set to a maximum bit level; both maximum and minimum price are specified so that content 114 within a target range is provided by the plurality of content providers 102 which provides the content proxy 110 the ability to control quality within a range; text only format is specified so that images contained in the content 114 provided by the content providers 102 are totally eliminated; and recompression is specified where images provided from the content provider 102 are compressed with additional compression techniques beyond any compression techniques used by the content provider 102.

Although the present invention has been described with reference to a number of illustrative embodiments thereof, it should be understood that numerous other modifications and embodiments can be devised by those skilled in the art that will fall within the spirit and scope of the principles of this invention. More particularly, variations in modifications are possible in the component parts and/or arrangements of the subject combination arrangement within the scope of the foregoing disclosure, the drawings, and the appended claims without departing from the spirit of the invention. In addition to variations and modifications in the component parts and/or arrangements, alternative uses will also be apparent to those skilled in the art.

For example, although the embodiments define the network as a wireless network and define the user as being a mobile user, the present invention is not limited thereto. Furthermore, as noted previously, the present invention is not limited to the specific specifications and protocols referred to in the specification.

While the invention has been described in terms of its preferred embodiments, it should be understood that numerous modifications may be made thereto without departing from the spirit and scope of the present invention. It is intended that all such modifications fall within the scope of the appended claims.

What is claimed is:

1. A method of charging a user for network access and/or services, the method comprising the steps of:
connecting a user of a wireless terminal to a network provided by a local network operator;
requesting at least one of a network access or a service by the user of the wireless terminal; and
providing from the local network operator a payment request to the user of the wireless terminal, the payment request including a selection of available alternatives for network access and/or services with corresponding charging information, and a selection of available payment methods for the network access and/or services with corresponding payment method information enabling the user of the wireless terminal to effect a payment;
sending payment information in response to the user of the wireless terminal making selections based on the payment request, the payment information including at least one selected alternative from the available alternatives for network access and/or services, and personal payment information of the user of the wireless terminal for effecting a payment corresponding to the at least one selected alternative from the available alternatives for network access and/or services; and
providing to the user of the wireless terminal in response to a receipt confirming the effected payment the corresponding at least one selected network access and/or service.

2. The method of claim 1, comprising the step of sending a receipt confirming the effected payment to the user of the wireless terminal in response to the effected payment prior to providing to the user of the wireless terminal the at least one selected network access and/or service.

3. The method of claim 1, comprising the step of providing by the local network operator an additional payment request to the user of the wireless terminal upon the network having completed providing the at least one selected network access and/or service.

4. The method of claim 1, comprising the step of sending a selection confirmation message to the user of the wireless terminal confirming the user made selections for network access and/or service in response to the sent payment information.

5. The method of claim 4, wherein the selection confirmation message comprises information relating to the user made selections for payment method.

6. The method of claim 1, wherein in the payment information is conveyed to a payment service provider.

7. The method of claim 6, wherein the receipt of confirming the effected payment is sent from the payment service provider.

8. The method of claim 7, comprising the step of sending a receipt confirming the effected payment to the user of the wireless terminal in response to the effected payment prior to providing to the user of the wireless terminal the at least one selected network access and/or service.

9. The method of claim 6, wherein the payment service provider is a third party wallet.

10. The method of claim 1, wherein the personal payment information comprises electronic money.

11. The method of claim 1, wherein the user of the wireless terminal is provided with information of a selection of available alternatives for network access and/or bargaining for services prior the user sending a communication request for at least one of network access or service.

12. The method of claim 1, wherein the network comprises a wireless short range radio network and the wireless terminal of the user communicates with the short range radio network.

13. The method of claim 11, wherein the wireless short range radio network conforms the principles of one of the Bluetooth technology, the IEEE 802.11 Wireless LAN standard and the HyperLAN standard.

14. The method of claim 1, wherein the step of requesting for at least one of a network access or a service by the user of the wireless terminal contains a request for a network connection having at least one specified characteristic.

15. The method of claim 14, wherein the at least one specified characteristic comprises one or more of bit rate, quality of service, and time delay.

16. The method of claim 1, wherein the corresponding charging information of the available alternatives for network access and/or services included in the payment request provided by the local network operator comprises a cost per unit time information of the available alternatives for network access and/or services.

17. The method of claim 1, wherein the payment method information included in the payment request provided by the local network operator comprises an account number of the local network operator.

18. The method of claim 1, wherein the personal payment information of the user of the wireless terminal included in the sent payment information comprises:
an account number of the local network operator;
an account number of the user of the wireless terminal; and
an amount of money to be transferred from the account number of the user of the wireless terminal to the account number of the local network operator.

19. A system comprising:
a wireless terminal; and
a network coupled to the wireless terminal by a local network operator; and wherein
a user of a wireless terminal is connected to a network provided by a local network operator;
at least one of a network access or a service is requested by a user of the wireless terminal;
a payment request is provided from the local network operator to the user of the wireless terminal, the payment request including a selection available alternatives for network access and/or services with corresponding charging information, and a selection of available payment methods for the network access and/or services with corresponding payment method information enabling the user of the wireless terminal to effect a payment;
payment information is provided in response to the user of the wireless terminal making selections based on the payment request, the payment information including at least one selected alternative from the available alternatives for network access and/or services, and personal payment information of the user of the wireless terminal for effecting a payment corresponding to the at least one selected alternative from the available alternatives for network access and/or services; and
the user of the wireless terminal in response to a receipt confirming the effected payment is provided the corresponding at least one selected network access and/or service.

20. A system in accordance with claim 19, wherein a receipt confirming the effected payment is sent to the user of the wireless terminal in response to the effected payment prior to providing to the user of the wireless terminal the at least one selected network access and/or service.

21. The system of claim 19, wherein:
the local network operator provides an additional payment request to the user of the wireless terminal upon the network having completed providing the at least one selected network access and/or service.

22. The system of claim 19, wherein:
a selection confirmation message is sent to the user of the wireless terminal confirming the user made selections for network access and/or service in response to the sent payment information.

23. The system of claim 22, wherein the selection confirmation on message further comprises information relating to the user made selections for payment method.

24. The system of claim 19, wherein the system comprises a payment service provide and payment information is conveyed to the payment service provider.

25. The system of claim 24, wherein the receipt of confirming the effected payment is sent from the payment service provider.

26. The system of claim 25, wherein a receipt confirming the effected payment is sent to the user of the wireless terminal in response to the effected payment prior to providing to the user of the wireless terminal the at least one selected network access and/or service.

27. The method of claim 24, wherein the payment service provider is a third party wallet.

28. The method of claim 19, wherein the personal payment information comprises electronic money.

29. The system of claim 19, wherein the user of the wireless terminal is provided with information of a selection of available alternatives for network access and/or bargaining services prior to the user sending a communication request for at least one of a network access or service.

30. The system of claim 19, wherein the network comprises a wireless short range radio network and the wireless terminal of the user communicates with the short range radio network.

31. The system of claim 29, wherein the wireless short range radio network conforms the principles of one of the Bluetooth technology, the IEEE 802.11 Wireless LAN standard and the HyperLAN standard.

32. The system of claim 29, wherein the requesting for at least one of a network access or a service by the user of the wireless terminal contains a request for a network connection having at least one specified characteristic.

33. The system of claim 32, wherein the at least one characteristic comprises one or more of bit rate, quality of service, and time delay.

34. The system of claim 29, wherein the corresponding charging information of the available alternatives for network access and/or services included in the payment request provided by the local network operator comprises a cost per unit time information of the available alternatives for network access and/or services.

35. The system of claim 19, wherein the payment method information included in the payment request provided by the local network operator comprises an account number of the local network operator.

36. The system of claim 19, wherein the personal payment information of the user of the wireless terminal included in the sent payment information comprises:
an account number of the local network operator;
an account number of the user of the wireless terminal; and
an amount of money to be transferred from the account number of the user of the wireless terminal to the account number of the local network operator.

37. In a system comprising a wireless terminal and a network coupled to the wireless terminal by a local network operation, a method of operation of the wireless terminal comprising:
connecting a user of the wireless terminal to the network;
requesting at least one of a network access or a service by the user of the wireless terminal;
providing from the local network operator to the user of the wireless terminal a payment request including a selection of available alternatives for network access and/or services with corresponding charging information, and a selection of available payment methods for the network access and/or services with corresponding payment method information enabling the user of the wireless terminal to effect a payment; and wherein the system sends payment information in response to the user of the wireless terminal making selections based on the payment request, the payment information including at least one selected alternative from the available alternatives for network access and/or services, and personal payment information of the user of the wireless terminal for effecting a payment corresponding to the at least one selected alternative from the available alternatives for network access and/or services; and
providing to the user of the wireless terminal in response to a receipt confirming the effected payment the corresponding at least one selected network access and/or service.

38. The method of claim 37, comprising the step of sending a receipt confirming the effected payment to the user of the wireless terminal in response to the effected payment prior to providing to the user of the wireless terminal the at least one selected network access and/or service.

39. The method of claim 37, comprising the step of providing by the local network operator an additional payment request to the user of the wireless terminal upon the network having completed providing the at least one selected network access and/or service.

40. The method of claim 31, comprising the step of sending a selection confirmation message to the user of the wireless terminal confirming the user made selections for network access and/or service in response to the sent payment information.

41. The method of claim 40, wherein the selection confirmation message further comprises information relating to the user made selections for payment method.

42. The method of claim 37, wherein in the payment information is conveyed to a payment service provider.

43. The method of claim 42, wherein the receipt of confirming the effected payment is sent from the payment service provider.

44. The method of claim 43, comprising the step of sending a receipt confirming the effected payment to the user of the wireless terminal in response to the effected payment prior to providing to the user of the wireless terminal the at least one selected network access and/or service.

45. The method of claim 42, wherein the payment service provider is a third party wallet.

46. The method of claim 37, wherein the personal payment information comprises electronic money.

47. The method of claim 37, wherein the user of the wireless terminal is provided with information of a selection of available alternatives for network access and/or bargaining for services prior the user sending a communication request for at least one of network access or service.

48. The method of claim 37, wherein the network comprises a wireless short range radio network and the wireless terminal of the user communicates with the short range radio network.

49. The method of claim 47, wherein the wireless short range radio network conforms to one of the Bluetooth technology, the IEEE 802.11 Wireless LAN standard and the HyperLAN standard.

50. The method of claim 37, wherein the step of requesting for at least one of the network access or a service by the user of the wireless terminal contains a request for a network connection having at least one specified characteristic.

51. The method of claim 50, wherein the at least one characteristic comprises one or more of bit rate, quality of service, and time delay.

52. The method of claim 37, wherein the corresponding charging information of the available alternatives for network access and/or services included in the payment request provided by the local network operator comprises a cost per unit time information of the available alternatives for network access and/or services.

53. The method of claim 37, wherein the payment method information included in the payment request provided by the local network operator comprises an account number of the local network operator.

54. The method of claim 37, wherein the personal payment information of the user of the wireless terminal included in the sent payment information comprises:
an account number of the local network operator;
an account number of the user of the wireless terminal; and
an amount of money to be transferred from the account number of the user of the wireless terminal to the account number of the local network operator.

55. A system comprising:
at least one terminal, each terminal receiving processed content;
at least one content provider, each content provider providing content; and
at least one processor, each processor, being coupled to the at least one content provider and to the at least one terminal, and processing the content with a profile of the at least one terminal, the profile controlling the processing of the content provided by the at least one content provider to provide the processed content received by the at least one terminal.

56. A system in accordance with claim 55 comprising:
local wireless service provider, coupled to the at least one processor and the at least one terminal, which transmits the processed content to the at least one terminal; and wherein
the at least one processor, in response to the profile of the at least one terminal, reduces a quantity of data contained in the content provided from the at least one content provider to provide the processed content received by the at least one terminal from the local wireless service provider.

57. A system in accordance with claim 56 wherein:
the profile specifies a compression level of the processed content provided by the at least one processor.

58. A system in accordance with claim 56 wherein:
the profile specifies a maximum charge for receiving the processed content by the at least one terminal.

59. A system in accordance with claim 58 wherein:
the profile specifies a minimum charge for receiving the processed content by the at least one terminal.

60. A system in accordance with claim 56 wherein:
the profile specifies a maximum size of images in the processed content to be received by the at least one terminal; and
the at least one processor processes images within the content received from the at least one content provider to conform images in the content to be within the maximum size of images which may be displayed by a display of the at least one terminal.

61. A system in accordance with claim 56 wherein:
the profile specifies that the processed content contains only text.

62. A system in accordance with claim 55 comprising:
a billing module, associated with the at least one processor, which charges for the reception of the processed content by the at least one terminal a fraction of a difference between a charge that the at least one terminal would have been charged by the local wireless service provider if the content provided by the at least one content provider was transmitted to the at least one terminal without processing less a charge charged by the local wireless service provider for transmitting the processed content to the at least one terminal.

63. A system in accordance with claim 56 comprising:
a billing module, associated with the at least one processor, which charges for the reception of the processed content by the at least one terminal a fraction of a difference between a charge that the at least one terminal would have been charged by the local wireless service provider if the content provided by the at least one content provider was transmitted to the at least one terminal without processing less a charge charged by the local wireless service provider for transmitting the processed content to the at least one terminal.

64. A system in accordance with claim 57 comprising:
a billing module, associated with the at least one processor, which charges for the reception of the processed content by the at least one terminal a fraction of a difference between a charge that the at least one terminal would have been charged by the local wireless service provider if the content provided by the at least one content provider was transmitted to the at least one terminal without processing less a charge charged by the local wireless service provider for transmitting the processed content to the at least one terminal.

65. A system in accordance with claim 58 comprising:
a billing module, associated with the at least one processor, which charges for the reception of the processed content by the at least one terminal a fraction of a difference between a charge that the at least one terminal would have been charged by the local wireless service provider if the content provided by the at least one content provider was transmitted to the at least one terminal without processing less a charge charged by the local wireless service provider for transmitting the processed content to the at least one terminal.

66. A system in accordance with claim 59 comprising:
a billing module, associated with the at least one processor, which charges for the reception of the processed content by the at least one terminal a fraction of a difference between a charge that the at least one terminal would have been charged by the local wireless service provider if the content provided by the at least one content provider was transmitted to the at least one terminal without processing less a charge charged by the local wireless service provider for transmitting the processed content to the at least one terminal.

67. A system in accordance with claim 60 comprising:
a billing module, associated with the at least one processor, which charges for the reception of the processed content by the at least one terminal a fraction of a difference between a charge that the at least one terminal would have been charged by the local wireless service provider if the content provided by the at least one content provider was transmitted to the at least one terminal without processing less a charge charged by the local wireless service provider for transmitting the processed content to the at least one terminal.

68. A system in accordance with claim 61 comprising:
a billing module, associated with the at least one processor, which charges for the reception of the processed content by the at least one terminal a fraction of a difference between a charge that the at least one terminal would have been charged by the local wireless service provider if the content provided by the at least one content provider was transmitted to the at least one terminal without processing less a charge charged by the local wireless service provider for transmitting the processed content to the at least one terminal.

69. A system in accordance with claim 55 wherein:
the at least one terminal is a client of the at least one content provider with each content provider comprising a server and the at least one processor being a proxy of the at least one content provider.

70. A method of providing processed content to at least one terminal comprising:
providing at least one content provider which provides processed content;
coupling at least one processor to the at least one content provider and to the at least one terminal; and
the at least one processor processes the content provided by the at least one content provider to produce the processed content which is received by the at least one terminal in accordance with a profile of the at least one terminal, the profile controlling the processing of the content provided by the at least one content provider to provide the processed content received by the at least one terminal.

71. A method in accordance with claim 70 comprising:
a local wireless service provider, coupled to the at least one processor and the at least one terminal, which transmits the processed content to the at least one terminal; and wherein
the at least one processor, in response to the profile of the at least one terminal, reduces a quantity of data contained in the content provided from the at least one content provider to provide the processed content received by the at least one terminal.

72. A method in accordance with claim 71 wherein:
the profile specifies a compression level of the processed content provided by the at least one processor.

73. A method in accordance with claim 71 wherein:
the profile specifies a maximum charge for receiving the processed content by the at least one terminal.

74. A method in accordance with claim 73 wherein:
the profile specifies a minimum charge for receiving the processed content by the at least one terminal.

75. A method in accordance with claim 71 wherein:
the profile specifies a maximum size of images in the processed content to be received by the at least one terminal; and
the at least one processor processes images within the content received from the at least one content provider to conform images in the content to be within the maximum size of images which may be displayed by a display of the at least one terminal.

76. A method in accordance with claim 71 wherein:
the profile specifies that the processed content contains only text.

77. A method in accordance with claim 70 comprising:
providing a billing module associated with the at least one processor; and
the billing module charges for the reception of the processed content by the at least one terminal, the charge being a fraction of a difference between a charge that the at least one terminal would have been charged by the local wireless service provider if the content provided by the at least one content provider was transmitted to the at least one terminal without processing less a charge charged by the local wireless service provider for transmitting the processed content to the at least one terminal.

78. A method in accordance with claim 71 comprising:
providing a billing module associated with the at least one processor; and
the billing module charges for the reception of the processed content by the at least one terminal, the charge being a fraction of a difference between a charge that the at least one terminal would have been charged by the local wireless service provider if the content provided by the at least one content provider was transmitted to the at least one terminal without processing less a charge charged by the local wireless service provider for transmitting the processed content to the at least one terminal.

79. A method in accordance with claim 72 comprising:
providing a billing module associated with the at least one processor; and
the billing module charges for the reception of the processed content by the at least one terminal, the charge being a fraction of a difference between a charge that the at least one terminal would have been charged by the local wireless service provider if the content provided by the at least one content provider was transmitted to the at least one terminal without processing less a charge charged by the local wireless service provider for transmitting the processed content to the at least one terminal.

80. A method in accordance with claim 73 comprising:
providing a billing module associated with the at least one processor; and
the billing module charges for the reception of the processed content by the at least one terminal, the charge being a fraction of a difference between a charge that the at least one terminal would have been charged by the local wireless service provider if the content provided by the at least one content provider was transmitted to the at least one terminal without processing less a charge charged by the local wireless service provider for transmitting the processed content to the at least one terminal.

81. A method in accordance with claim 74 comprising:
providing a billing module associated with the at least one processor; and
the billing module charges for the reception of the processed content by the at least one terminal, the charge being a fraction of a difference between a charge that the at least one terminal would have been charged by the local wireless service provider if the content provided by the at least one content provider was transmitted to the at least one terminal without processing less a charge charged by the local wireless service provider for transmitting the processed content to the at least one terminal.

82. A method in accordance with claim 75 comprising:
providing a billing module associated with the at least one processor; and
the billing module charges for the reception of the processed content by the at least one terminal, the charge being a fraction of a difference between a charge that the at least one terminal would have been charged by the local wireless service provider if the content provided by the at least one content provider was transmitted to the at least one terminal without processing less a charge charged by the local wireless service provider for transmitting the processed content to the at least one terminal.

83. A method in accordance with claim 76 comprising:
providing a billing module associated with the at least one processor; and
the billing module charges for the reception of the processed content by the at least one terminal, the charge being a fraction of a difference between a charge that the at least one terminal would have been charged by the local wireless service provider if the content provided by the at least one content provider was transmitted to the at least one terminal without processing less a charge charged by the local wireless service provider for transmitting the processed content to the at least one terminal.

84. In a system including at least one terminal, each terminal receiving processed content and at least one content provider, each content provider providing content, a content proxy comprising:
at least one processor, each processor being coupled to the at least one content provider and to the at least one terminal, and processing the content provided by the at least one content provider to produce the processed content which is received by the at least one terminal in accordance with a profile of the at least one terminal, the profile controlling the processing of the content provided by the at least one content provider to provide the processed content received by the at least one terminal.

85. A content proxy in accordance with claim 84 wherein:
a local wireless service provider, coupled to the at least one processor and the at least one terminal, which transmits the processed content to the at least one terminal; and wherein
the at least one processor, in response to the profile of the at least one terminal, reduces a quantity of data contained in the content provided from the at least one content provider to provide the processed content received by the at least one terminal from the local wireless service provider.

86. A content proxy in accordance with claim 85 wherein:
the profile specifies a compression level of the processed content provided by the at least one processor.

87. A content proxy in accordance with claim 85 wherein:
the profile specifies a maximum charge for receiving the processed content by the at least one terminal.

88. A content proxy in accordance with claim 87 wherein:
the profile specifies a minimum charge for receiving the processed content by the at least one terminal.

89. A content proxy in accordance with claim 85 wherein:
the profile specifies a maximum size of images in the processed content to be received by the at least one terminal; and
the at least one processor processes images within the content received from the at least one content provider to conform images in the content to be within the maximum size of images which may be displayed by a display of the at least one terminal.

90. A content proxy in accordance with claim 85 wherein:
the profile specifies that the processed content contains only text.

91. A content proxy in accordance with claim 85 comprising:
a billing module, associated with the at least one processor, which charges for the reception of the processed content by the at least one terminal a fraction of a difference between a charge that the at least one terminal would have been charged by the local wireless service provider if the content provided by the at least one content provider was transmitted to the at least one terminal without processing less a charge charged by the local wireless service provider for transmitting the processed content to the at least one terminal.

92. A content proxy in accordance with claim 86 comprising:
a billing module, associated with the at least one processor, which charges for the reception of the processed content by the at least one terminal a fraction of a difference between a charge that the at least one terminal would have been charged by the local wireless service provider if the content provided by the at least one content provider was transmitted to the at least one terminal without processing less a charge charged by the local wireless service provider for transmitting the processed content to the at least one terminal.

93. A content proxy in accordance with claim 86 comprising:
a billing module, associated with the at least one processor, which charges for the reception of the processed content by the at least one terminal a fraction of a difference between a charge that the at least one terminal would have been charged by the local wireless service provider if the content provided by the at least one content provider was transmitted to the at least one terminal without processing less a charge charged by the local wireless service provider for transmitting the processed content to the at least one terminal.

94. A content proxy in accordance with claim 87 comprising:
a billing module, associated with the at least one processor, which charges for the reception of the processed content by the at least one terminal a fraction of a difference between a charge that the at least one terminal would have been charged by the local wireless service provider if the content provided by the at least one content provider was transmitted to the at least one terminal without processing less a charge charged by the local wireless service provider for transmitting the processed content to the at least one terminal.

95. A content proxy in accordance with claim 88 comprising:
a billing module, associated with the at least one processor, which charges for the reception of the processed content by the at least one terminal a fraction of a difference between a charge that the at least one terminal would have been charged by the local wireless service provider if the content provided by the at least one content provider was transmitted to the at least one terminal without processing less a charge charged by the local wireless service provider for transmitting the processed content to the at least one terminal.

96. A content proxy in accordance with claim 89 comprising:
a billing module, associated with the at least one processor, which charges for the reception of the processed content by the at least one terminal a fraction of a difference between a charge that the at least one terminal would have been charged by the local wireless service provider if the content provided by the at least one content provider was transmitted to the at least one terminal without processing less a charge charged by the local wireless service provider for transmitting the processed content to the at least one terminal.

97. A content proxy in accordance with claim 90 comprising:
a billing module, associated with the at least one processor, which charges for the reception of the processed content by the at least one terminal a fraction of a difference between a charge that the at least one terminal would have been charged by the local wireless service provider if the content provided by the at least one content provider was transmitted to the at least one terminal without processing less a charge charged by the local wireless service provider for transmitting the processed content to the at least one terminal.
